(19) United States
(12) Patent Application Publication
(10) Pub. No.: US 2026/0121565 A1
(43) Pub. Date: Apr. 30, 2026

(54) MOTOR CONTROL DEVICE AND MOTOR UNIT

(71) Applicant: NIDEC POWERTRAIN SYSTEMS CORPORATION, Zama-shi (JP)

(72) Inventor: Kei SATO, Zama-shi (JP)

(21) Appl. No.: 19/374,432

(22) Filed: Oct. 30, 2025

(30) Foreign Application Priority Data
Oct. 31, 2024 (JP) 2024-191510

(51) Int. Cl. H02P 23/14; G05B 19/04

(52) U.S. Cl. CPC H02P 23/14; G05B 19/041

(57) ABSTRACT

A motor control device to control a motor by feedback control includes an inverter to convert a DC voltage to a three-phase AC voltage and output the three-phase AC voltage to the motor, a current sensor to detect a three-phase current flowing through the motor, and a controller configured or programmed to control an output duty of the inverter by controlling the inverter by PWM, based on an output signal of the current sensor. The controller is configured or programmed to execute acquisition processing to acquire a discrete three-phase current being a discrete-time signal by sampling an output signal of the current sensor at a sampling cycle shorter than a cycle of the feedback control, and duty calculation processing to reduce a subsequent output duty of the inverter to be smaller than a current output duty of the inverter when the discrete three-phase current exceeds a target current value.

### CROSS-REFERENCE TO RELATED APPLICATIONS

The present application claims priority under 35 U.S.C. § 119 to Japanese Patent Application No. 2024-191510, filed on Oct. 31, 2024, the entire contents of which are hereby incorporated herein by reference.

### 1. FIELD OF THE INVENTION

The present disclosure relates to motor control devices and motor assemblies.

### 2. BACKGROUND

In general, there has been known a technique for controlling a motor by feedback control using pulse width modulation. When an increase in load is caused during rotation control of the motor, a large current flows through the motor. In general, this current is reduced by PID control and current feedback control. However, when a load increase that is rapid relative to a cycle of the feedback control is caused, control hardware may be damaged before the large current is reduced by the control.

In order to solve the above-mentioned problem, it is conceived to shorten the cycle of the feedback control. However, shortening the cycle of the feedback control increases a computational load on control equipment. Thus, there is a demand for achieving current suppression control that can quickly respond to the rapid load increase by simple calculation, without shortening the cycle of the feedback control.

### SUMMARY

An example embodiment of a motor control device according to the present disclosure is a motor control device to control a motor by feedback control, and includes an inverter to convert a DC voltage to a three-phase AC voltage and output the three-phase AC voltage to the motor, a current sensor to detect a three-phase current flowing through the motor, and a controller configured or programmed to control an output duty of the inverter by controlling the inverter by pulse width modulation, based on an output signal of the current sensor. The controller is configured or programmed to execute acquisition processing to acquire a discrete three-phase current I[n] being a discrete-time signal by sampling an output signal of the current sensor at a sampling cycle shorter than a cycle of the feedback control, and duty calculation processing to reduce a subsequent output duty D[n+1] of the inverter to be smaller than a current output duty D[n] of the inverter when the discrete three-phase current I[n] exceeds a target current value Itgt.

An example embodiment of a motor assembly according to the present disclosure includes a motor and the motor control device according to the above-mentioned example embodiment configured or programmed to control the motor by feedback control.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram schematically illustrating an overall configuration of a motor assembly of the present example embodiment.

FIG. 2 is a functional block diagram illustrating functions of a controller of the present example embodiment.

FIG. 3 is a diagram illustrating an example of a state in which a three-phase current flowing through a motor changes when a sudden load increase is caused during rotation control of the motor by general feedback control.

FIG. 4 is a diagram illustrating an example of a state in which a consumed current of an inverter changes when a sudden load increase is caused during the rotation control of the motor by the general feedback control.

FIG. 5 is a diagram illustrating an example of a state in which a three-phase current flowing through a motor changes when a sudden load increase is caused during rotation control of the motor by a controller of the present example embodiment.

FIG. 6 is a diagram illustrating an example of a state in which a consumed current of an inverter changes when a sudden load increase is caused during the rotation control of the motor by the controller of the present example embodiment.

### DETAILED DESCRIPTION

Example embodiments of the present disclosure are described below with reference to the drawings.

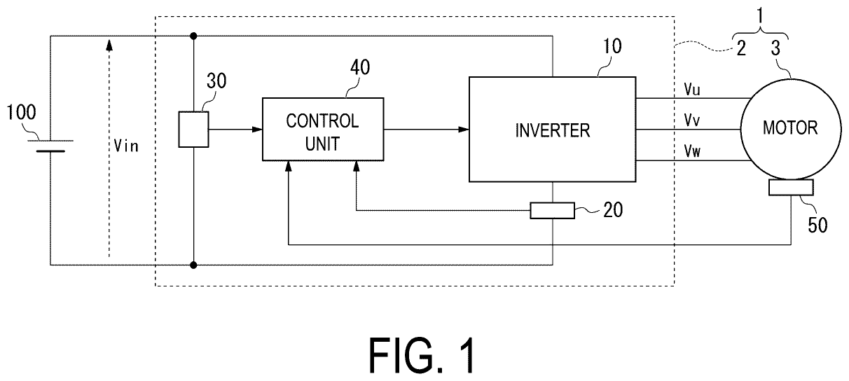

FIG. 1 is a diagram schematically illustrating an overall configuration of a motor assembly 1 of the present example embodiment. As illustrated in FIG. 1, the motor assembly 1 includes a motor control device 2 and a motor 3. The motor control device 2 is electrically connected to the motor 3. Further, the motor control device 2 is electrically connected to a DC power source 100.

The motor control device 2 controls the motor 3 by the feedback control. For example, the motor 3 is a three-phase brushless DC motor. The motor 3 includes a speed sensor 50. The speed sensor 50 detects the rotational speed of the motor 3, and outputs a signal indicating the detection result of the rotational speed to the motor control device 2. Note that, when the motor control device 2 includes a function of estimating the rotational speed of the motor 3, based on the three-phase current flowing through the motor 3, the motor 3 is not required to include the speed sensor 50.

The motor control device 2 includes an inverter 10, a current sensor 20, a voltage sensor 30, and a controller 40.

The inverter 10 is electrically connected to each of the DC power source 100 and the motor 3. The inverter 10 converts a DC voltage Vin that is output from the DC power source 100 into a three-phase AC voltage, and outputs the three-phase AC voltage to the motor 3. The three-phase AC voltage includes a U-phase voltage Vu, a V-phase voltage Vv, and a W-phase voltage Vw.

Six gate control signals that are output from the controller 40 are input to the inverter 10. Note that, in FIG. 1, the six gate control signals that are output from the controller 40 to the inverter 10 are indicated by one arrow line. The inverter 10 converts the DC voltage Vin into the three-phase AC voltage, based on the six gate control signals. For example, the inverter 10 includes a three-phase full-bridge circuit configured by six switching elements. In an example, the switching elements configuring the three-phase full-bridge circuit are MOS-FETs. The configuration of such a three-phase full-bridge circuit is generally known, and thus illustration thereof is omitted.

Although not illustrated, the inverter 10 includes a gate driver configured by a semiconductor IC chip. The six gate control signals are input to the gate driver. The gate driver includes a function of converting a voltage value of each of the gate control signals into a value that enables driving of a gate of each of the switching elements. Each of the gate control signals is supplied via the gate driver to a gate of the switching element corresponding one-on-one to each of the gate control signals.

In accordance with a level of the gate control signal corresponding one-on-one to each of the switching elements, the state of the six switching elements included in the three-phase full-bridge circuit are controlled between an on state and an off state. With this, the DC voltage Vin is converted into the three-phase AC voltage. Note that, as described later, each of the gate control signals is a signal subjected to pulse width modulation, and a duty of each of the gate control signals is controlled by the controller 40. The three-phase AC voltage that is output from the inverter 10 is a pulse voltage having the same duty as the duty of the gate control signal. In the following description, the duty of the pulse voltage that is output from the inverter 10 is also referred to as an output duty of the inverter 10 in some cases.

The current sensor 20 is electrically connected between a negative terminal of the DC power source 100 and the inverter 10, and detects the three-phase current flowing through the motor 3. The current sensor 20 outputs a signal indicating the detection result of the three-phase current to the controller 40. For example, the current sensor 20 is a shunt resistor.

The voltage sensor 30 is electrically connected between the positive terminal and the negative terminal of the DC power source 100, and detects the DC voltage Vin that is output from the DC power source 100. The voltage sensor 30 outputs a signal indicating the detection result of the DC voltage Vin to the controller 40. For example, the voltage sensor 30 is a resistive voltage divider circuit. Note that, as described later, the voltage sensor 30 is not a necessary constituent element.

Output signals of the current sensor 20, the voltage sensor 30, and the speed sensor 50 are input to the controller 40. The controller 40 controls the output duty of the inverter 10 by controlling the inverter 10 by pulse width modulation, based on the output signals of the current sensor 20, the voltage sensor 30, and the speed sensor 50. The expression “the inverter 10 is controlled by pulse width modulation” indicates that the duties of the six gate control signals that are output to the inverter 10 are controlled.

For example, the controller 40 is a micro-processor such as a micro-controller unit (MCU). Although details are described later, the controller 40 executes acquisition processing for acquiring a discrete three-phase current I[n] being a discrete-time signal by sampling the output signal of the current sensor 20 at a sampling cycle shorter than a cycle of the feedback control, and duty calculation processing for reducing a subsequent output duty D[n+1] of the inverter 10 to be smaller than a current output duty D[n] of the inverter 10 when the discrete three-phase current I[n] exceeds a target current value Itgt.

The current output duty D[n] of the inverter 10 is an output duty of the inverter 10 in one sampling period during which the discrete three-phase current I[n] is acquired. One sampling period is a time period between two sampling timings adjacent in time. In other words, a length of one sampling period is equal to the sampling cycle of the output signal of the current sensor 20. The subsequent output duty D[n+1] of the inverter 10 is an output duty of the inverter 10 in one sampling period subsequent to the one sampling period during which the discrete three-phase current I[n] is acquired. As is well known, n is an integer referred to as an index, which is used to indicate a discrete-time signal.

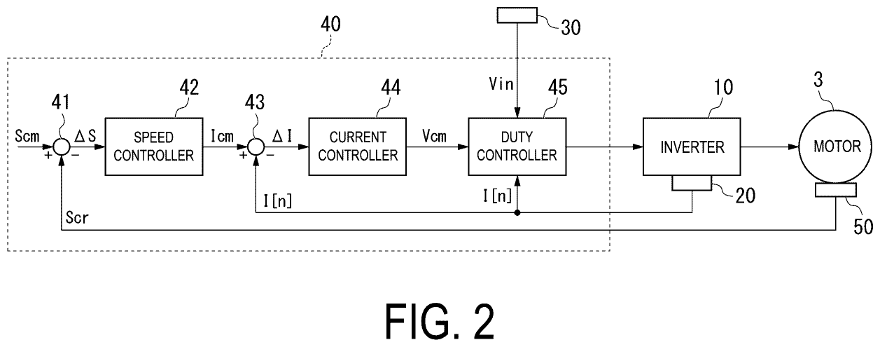

FIG. 2 is a functional block diagram illustrating functions of the controller 40. As illustrated in FIG. 2, the controller 40 includes, as function blocks, a first subtractor 41, a speed controller 42, a second subtractor 43, a current controller 44, and a duty controller 45. The functions of the controller 40, which are indicated by those functional blocks, may be functions achieved by hardware, or may be functions achieved by executing a program by one or more processor cores. Alternatively, the functions of the controller 40 may be functions achieved by a combination of hardware and software.

The first subtractor 41 calculates a speed deviation ΔS being a deviation between a rotational speed command value Scm and a present rotational speed Scr by subtracting the present rotational speed Scr of the motor 3 from the rotational speed command value Scm of the motor 3. Note that, in FIG. 2, the arrow line is drawn to indicate that the output signal of the speed sensor 50 is directly input to the first subtractor 41. However, in actuality, the controller 40 includes a function of acquiring the present rotational speed Scr as a digital value, based on the output signal of the speed sensor 50.

The speed controller 42 calculates a three-phase current command value Icm at which the speed deviation ΔS is zero, by executing PID control based on the speed deviation ΔS. The second subtractor 43 calculates a current deviation ΔI being a deviation between the three-phase current command value Icm and the discrete three-phase current I[n] by subtracting the discrete three-phase current I[n] from the three-phase current command value Icm. Note that, in FIG. 2, the arrow line is drawn to indicate that the output signal of the current sensor 20 is directly input to the second subtractor 43. However, as described above, in actuality, the controller 40 includes a function of acquiring the discrete three-phase current I[n] by sampling the output signal of the current sensor 20 at a predetermined sampling cycle.

The current controller 44 calculates a three-phase voltage command value Vcm at which the current deviation ΔI is zero, by executing the PID control based on the current deviation ΔI. The duty controller 45 controls the output duty of the inverter 10 by controlling the duties of the six gate control signals that are output to the inverter 10, based on the three-phase voltage command value Vcm, the discrete three-phase current I[n], and the DC voltage Vin that is detected by the voltage sensor 30. Note that, in FIG. 2, the arrow line is drawn to indicate that the output signal of the voltage sensor 30 is directly input to the duty controller 45. However, in actuality, the controller 40 includes a function of acquiring the DC voltage Vin as a digital value, based on the output signal of the voltage sensor 30.

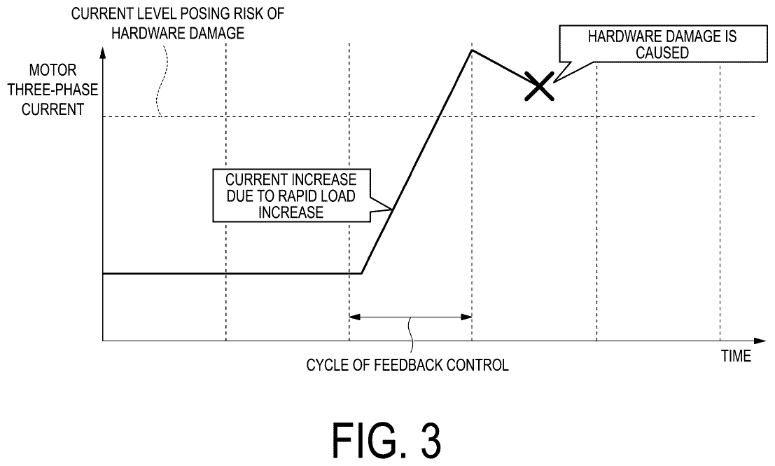

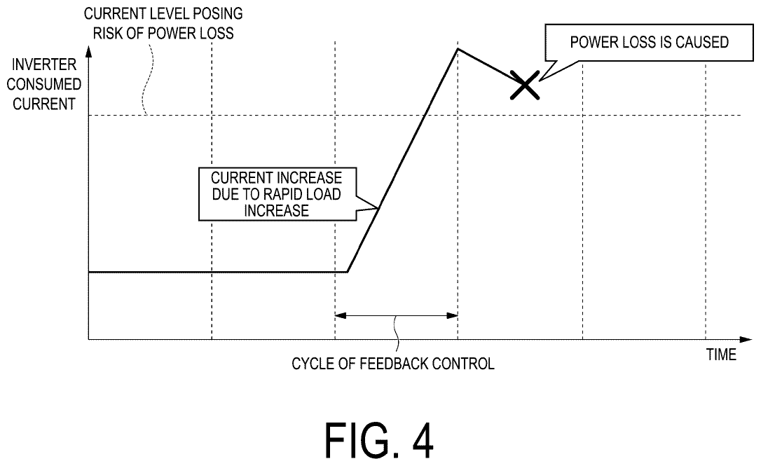

The operation of the duty controller 45 is described below in detail. Note that, before the operation of the duty controller 45 is described, problems in the related art are described below with reference to FIG. 3 and FIG. 4 for easy understanding of the operation of the duty controller 45.

FIG. 3 is a diagram illustrating an example of a state in which a three-phase current flowing through a motor changes when a sudden load increase is caused during rotation control of the motor by general feedback control. As illustrated in FIG. 3, when a load increase is caused during the rotation control of the motor, a large three-phase current flows through the motor. In general, this current is reduced by PID control and current feedback control. However, when a load increase that is rapid relative to a cycle of the feedback control is caused, control hardware may be damaged before a large current is reduced by the control.

FIG. 4 is a diagram illustrating an example of a state in which a consumed current of an inverter changes when a sudden load increase is caused during the rotation control of the motor by the general feedback control. As illustrated in FIG. 4, when a rapid load increase is caused during the rotation control of the motor, a large three-phase current flows through the motor. Thus, the consumed current of the inverter is also increased. In general, this current is reduced by PID control and current feedback control. However, when a load increase that is rapid relative to a cycle of the feedback control is caused, the power supply voltage may be rapidly reduced due to a sudden increase in consumed current, and damage to control hardware due to power loss or malfunction of other systems sharing the same power supply may be caused before a large current is reduced through control.

In order to solve the above-mentioned problem, it is conceived to shorten the cycle of the feedback control. However, shortening the cycle of the feedback control increases a computational load on control equipment. Thus, there is a demand for achieving current suppression control that can quickly respond to the rapid load increase by simple calculation, without shortening the cycle of the feedback control.

The controller 40 of the present example embodiment achieves the current suppression control described above.

As described above, the controller 40 executes the acquisition processing for acquiring the discrete three-phase current I[n] being a discrete-time signal by sampling the output signal of the current sensor 20 at a sampling cycle shorter than the cycle of the feedback control, and the duty calculation processing for reducing the subsequent output duty D[n+1] of the inverter 10 to be smaller than the current output duty D[n] of the inverter 10 when the discrete three-phase current I[n] exceeds the target current value Itgt.

The duty controller 45 executes the duty calculation processing described above. First, description is made on the duty calculation processing executed by the duty controller 45 when the target current value Itgt is a target value of the three-phase current flowing through the motor 3. In this case, the target current value Itgt may be set as “a current level posing a risk of hardware damage” illustrated in FIG. 3, or may be set to a value different from the current level.

When the target current value Itgt is the target value of the three-phase current flowing through the motor 3, the duty controller 45 may execute any one of first duty calculation processing, second duty calculation processing, third duty calculation processing, and fourth duty calculation processing as the duty calculation processing.

For example, the duty controller 45 executes, as the first duty calculation processing, first processing for determining whether the discrete three-phase current I[n] exceeds the target current value Itgt and second processing for calculating the subsequent output duty D[n+1], based on Equation (1) given below, when it is determined that the discrete three-phase current I[n] exceeds the target current value Itgt.

$$[ Math . 1 ]$$

$$D [ n + 1 ] = ( {I}_{tgt} / I [ n ] ) \times D [ n ] \qquad ( 1 )$$

Further, the duty controller 45 executes, as the second duty calculation processing, the first processing for determining whether the discrete three-phase current I[n] exceeds the target current value Itgt and third processing for calculating the subsequent output duty D[n+1], based on Equation (2) given below, when it is determined that the discrete three-phase current I[n] exceeds the target current value Itgt. In Equation (2) given below, Vin represents the DC voltage that is input to the inverter 10, and Vbemf represents a counter-electromotive voltage of the motor 3.

$$[ Math . 2 ]$$

$$D [ n + 1 ] = ( {I}_{tgt} / I [ n ] ) \times D [ n ] - [ ( {V}_{bemf} / {V}_{in} ) \times \{ 1 - ( {I}_{tgt} / I [ n ] ) \} ] \qquad ( 2 )$$

Further, the duty controller 45 calculates the subsequent output duty D[n+1], based on Equation (3) given below, as the third duty calculation processing. D′[n] in Equation (3) given below is expressed in Equation (4) given below.

$$[ Math . 3 ]$$

$$D [ n + 1 ] = min ( D [ n ] , {D}^{′} [ n ] ) \qquad ( 3 )$$

$${D}^{′} [ n ] = ( {I}_{tgt} / I [ n ] ) \times D [ n ] \qquad ( 4 )$$

Moreover, the duty controller 45 calculates the subsequent output duty D[n+1], based on Equation (3) given below, as the fourth duty calculation processing. D′[n] in Equation (3) given below is expressed in Equation (5) given below. In Equation (5) given below, Vin represents the DC voltage that is input to the inverter 10, and Vbemf represents the counter-electromotive voltage of the motor 3.

$$[ Math . 4 ]$$

$$D [ n + 1 ] = min ( D [ n ] , {D}^{′} [ n ] ) \qquad ( 3 )$$

$${D}^{′} [ n ] = ( {I}_{tgt} / I [ n ] ) \times D [ n ] - [ ( {V}_{bemf} / {V}_{in} ) \times \{ 1 - ( {I}_{tgt} / I [ n ] ) \} ] \qquad ( 5 )$$

As understood from Equation (1) to Equation (5) given above, when the discrete three-phase current I[n] exceeds the target current value Itgt, the subsequent output duty D[n+1] of the inverter 10 is reduced to be smaller than the current output duty D[n] of the inverter 10. Note that, when the duty controller 45 executes the first duty calculation processing or the third duty calculation processing, the voltage sensor 30 is not required. When the second duty calculation processing or the fourth duty calculation processing is executed, the duty controller 45 estimates the counter-electromotive voltage Vbemf of the motor 3, based on the output signal of the speed sensor 50.

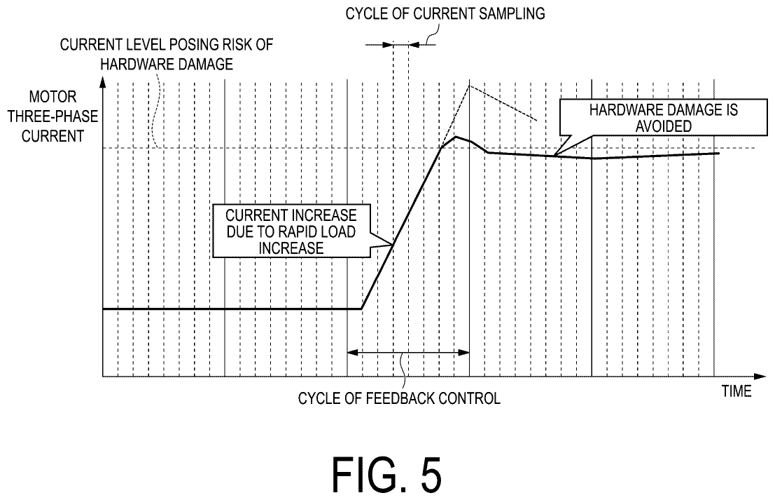

FIG. 5 is a diagram illustrating an example of a state in which the three-phase current flowing through the motor 3 changes when a sudden load increase is caused during rotation control of the motor 3 by the controller 40. When the discrete three-phase current I[n] exceeds the target current value Itgt (the current level posing a risk of hardware damage), the subsequent output duty D[n+1] of the inverter 10 is reduced to be smaller than the current output duty D[n] of the inverter 10. In this manner, the voltage applied to the motor is reduced by narrowing the output duty of the inverter 10 during a short time period in which the rotational speed of the motor 3 does not change. With this, a sudden increase in three-phase current caused by load fluctuation can be suppressed. In general, the sampling cycle of the current is shorter than the cycle of the feedback control. Thus, by reducing the output duty of the inverter 10 based on a result of such high-speed current sampling, three-phase current suppression control that can quickly respond to a rapid load increase can be achieved by simple calculation without shortening the cycle of the feedback control.

Next, description is made on the duty calculation processing executed by the duty controller 45 when the target current value Itgt is a target value of a consumed current of the inverter 10. In this case, the target current value Itgt may be set as “a current level posing a risk of power loss” illustrated in FIG. 4, or may be set to a value different from the current level.

When the target current value Itgt is the target value of the consumed current of the inverter 10, the duty controller 45 may execute any one of the fifth duty calculation processing and the sixth duty calculation processing as the duty calculation processing.

For example, the duty controller 45 executes, as the fifth duty calculation processing, the first processing for determining whether the discrete three-phase current I[n] exceeds the target current value Itgt and fourth processing for calculating the subsequent output duty D[n+1], based on Equation (6) given below, when it is determined that the discrete three-phase current I[n] exceeds the target current value Itgt.

$$[ Math . 5 ]$$

$$D [ n + 1 ] = {I}_{tgt} / I [ n ] \qquad ( 6 )$$

Further, the duty controller 45 calculates the subsequent output duty D[n+1], based on Equation (7) given below, as the sixth duty calculation processing.

$$[ Math . 6 ]$$

$$D [ n + 1 ] = min ( D [ n ] , {I}_{tgt} / I [ n ] ) \qquad ( 7 )$$

As understood from Equation (6) and Equation (7) given above, when the discrete three-phase current I[n] exceeds the target current value Itgt, the subsequent output duty D[n+1] of the inverter 10 is reduced to be smaller than the current output duty D[n] of the inverter 10. Note that, when the duty controller 45 executes the fifth duty calculation processing or the sixth duty calculation processing, the voltage sensor 30 is not required.

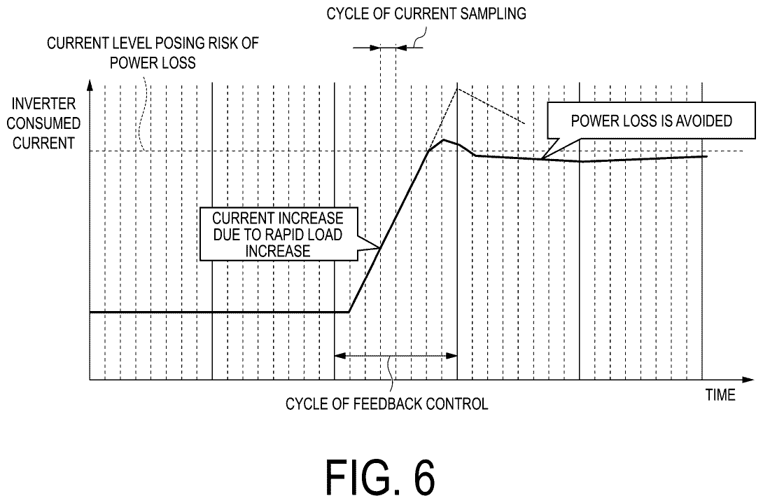

FIG. 6 is a diagram illustrating an example of a state in which a consumed current of the inverter 10 changes when a sudden load increase is caused during the rotation control of the motor 3 by the controller 40. When the discrete three-phase current I[n] exceeds the target current value Itgt (the current level posing a risk of power loss), the subsequent output duty D[n+1] of the inverter 10 is reduced to be smaller than the current output duty D[n] of the inverter 10. In this manner, the voltage applied to the motor is reduced by narrowing the output duty of the inverter 10 during a short time period in which the rotational speed of the motor 3 does not change. With this, a sudden increase in inverter consumed current caused by load fluctuation can be suppressed. In general, the sampling cycle of the current is shorter than the cycle of the feedback control. Thus, by reducing the output duty of the inverter 10 based on a result of such high-speed current sampling, inverter current suppression control that can quickly respond to a rapid load increase can be achieved by simple calculation without shortening the cycle of the feedback control.

As described above, the motor control device 2 of the present example embodiment is a motor control device that controls the motor 3 by the feedback control, and includes the inverter 10 that converts the DC voltage into the three-phase AC voltage and outputs the three-phase AC voltage to the motor 3, the current sensor 20 that detects the three-phase current flowing through the motor 3, and the controller 40 that controls the output duty of the inverter 10 by controlling the inverter 10 by pulse width modulation, based on the output signal of the current sensor 20. The controller 40 executes the acquisition processing for acquiring the discrete three-phase current I[n] being a discrete-time signal by sampling the output signal of the current sensor 20 at a sampling cycle shorter than the cycle of the feedback control, and the duty calculation processing for reducing the subsequent output duty D[n+1] of the inverter 10 to be smaller than the current output duty D[n] of the inverter 10 when the discrete three-phase current I[n] exceeds the target current value Itgt.

According to the present example embodiment described above, when the discrete three-phase current I[n] exceeds the target current value Itgt, by reducing the subsequent output duty D[n+1] of the inverter 10 to be smaller than the current output duty D[n] of the inverter 10, a sudden increase in current caused by load fluctuation can be suppressed by simple calculation, without shortening the cycle of the feedback control.

In the present example embodiment, the target current value Itgt is the target value of the three-phase current flowing through the motor 3.

In this case, a sudden increase in three-phase current caused by load fluctuation can be suppressed by simple calculation, without shortening the cycle of the feedback control.

In the present example embodiment, the controller 40 executes, as the first duty calculation processing, the first processing for determining whether the discrete three-phase current I[n] exceeds the target current value Itgt and the second processing for calculating the subsequent output duty D[n+1], based on Equation (1) given above, when it is determined that the discrete three-phase current I[n] exceeds the target current value Itgt.

According to the present example embodiment, the subsequent output duty D[n+1] is calculated based on Equation (1) that is simpler than Equation (2) given above. Thus, an increase in three-phase current can be suppressed by simpler calculation.

In the present example embodiment, the controller 40 executes, as the second duty calculation processing, the first processing for determining whether the discrete three-phase current I[n] exceeds the target current value Itgt and the third processing for calculating the subsequent output duty D[n+1], based on Equation (2) given below, when it is determined that the discrete three-phase current I[n] exceeds the target current value Itgt.

According to the present example embodiment, the subsequent output duty D[n+1] is calculated based on Equation (2) that includes, unlike Equation (1) given above, the input voltage of the inverter 10, the counter-electromotive voltage of the motor 3, and the like as parameters. Thus, the subsequent output duty D[n+1] that can suppress an increase in three-phase current can be calculated more accurately.

In the present example embodiment, the controller 40 calculates the subsequent output duty D[n+1], based on Equation (3) given above, as the third duty calculation processing. D′ [n] in Equation (3) given above is expressed in Equation (4) given above.

According to the present example embodiment, the subsequent output duty D[n+1] is calculated based on Equation (3) given above. Thus, when the discrete three-phase current I[n] exceeds the target current value Itgt, the subsequent output duty D[n+1] automatically becomes smaller than the current output duty D[n]. Thus, there is no need to execute the first processing for determining whether the discrete three-phase current I[n] exceeds the target current value Itgt. Moreover, the subsequent output duty D[n+1] is calculate based on Equation (4) that is simpler than Equation (5). Thus, an increase in three-phase current can be suppressed by simpler calculation.

In the present example embodiment, the controller 40 calculates the subsequent output duty D[n+1], based on Equation (3) given above, as the third duty calculation processing. D′ [n] in Equation (3) given above is expressed in Equation (5) given above.

According to the present example embodiment, the subsequent output duty D[n+1] is calculated based on Equation (3) given above. Thus, when the discrete three-phase current I[n] exceeds the target current value Itgt, the subsequent output duty D[n+1] automatically becomes smaller than the current output duty D[n]. Thus, there is no need to execute the first processing for determining whether the discrete three-phase current I[n] exceeds the target current value Itgt. Moreover, the subsequent output duty D[n+1] is calculated based on Equation (5) that includes, unlike Equation (4), the input voltage of the inverter 10, the counter-electromotive voltage of the motor 3, and the like as parameters. Thus, the subsequent output duty D[n+1] that can suppress an increase in three-phase current can be calculated more accurately.

In the present example embodiment, the target current value Itgt is the target value of the consumed current of the inverter 10.

In this case, a sudden increase in inverter consumed current caused by load fluctuation can be suppressed by simple calculation, without shortening the cycle of the feedback control.

In the present example embodiment, the controller 40 executes, as the fifth duty calculation processing, the first processing for determining whether the discrete three-phase current I[n] exceeds the target current value Itgt and the fourth processing for calculating the subsequent output duty D[n+1], based on Equation (6) given above, when it is determined that the discrete three-phase current I[n] exceeds the target current value Itgt.

According to the present example embodiment, the subsequent output duty D[n+1] is calculated based on Equation (6) that is simple and represented solely by the ratio of the target current value Itgt to the discrete three-phase current I[n]. Thus, an increase in inverter consumed current can be suppressed by simpler calculation.

In the present example embodiment, the controller 40 calculates the subsequent output duty D[n+1], based on Equation (7) given above, as the sixth duty calculation processing.

According to the present example embodiment, the subsequent output duty D[n+1] is calculated based on Equation (7) given above, Thus, when the discrete three-phase current I[n] exceeds the target current value Itgt, the subsequent output duty D[n+1] automatically becomes smaller than the current output duty D[n]. Thus, there is no need to execute the first processing for determining whether the discrete three-phase current I[n] exceeds the target current value Itgt.

The present disclosure is not limited to the above-mentioned example embodiment, and the respective configurations described in the present specification may be appropriately combined with each other, insofar as they are not inconsistent with one another.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor control device to control a motor by feedback control, the motor control device comprising:
an inverter to convert a DC voltage to a three-phase AC voltage and output the three-phase AC voltage to the motor;
a current sensor to detect a three-phase current flowing through the motor; and
a controller configured or programmed to control an output duty of the inverter by controlling the inverter by pulse width modulation, based on an output signal of the current sensor; wherein
the controller is configured or programmed to execute:
acquisition processing to acquire a discrete three-phase current I[n] being a discrete-time signal by sampling an output signal of the current sensor at a sampling cycle shorter than a cycle of the feedback control; and
duty calculation processing to reduce a subsequent output duty D[n+1] of the inverter to be smaller than a current output duty D[n] of the inverter when the discrete three-phase current I[n] exceeds a target current value Itgt.

2. The motor control device according to claim 1, wherein the target current value Itgt is a target value of the three-phase current flowing through the motor.

3. The motor control device according to claim 2, wherein the controller is configured or programmed to execute, as the duty calculation processing:
first processing to determine whether the discrete three-phase current I[n] exceeds the target current value Itgt; and
second processing to calculate the subsequent output duty D[n+1], based on Equation (1) when it is determined that the discrete three-phase current I[n] exceeds the target current value Itgt
$$Equation ( 1 )$$
$$D [ n + 1 ] = ( {I}_{tgt} / I [ n ] ) \times D [ n ] . \qquad ( 1 )$$

4. The motor control device according to claim 2, wherein
the controller is configured or programmed to execute, as the duty calculation processing:
first processing to determine whether the discrete three-phase current I[n] exceeds the target current value Itgt; and
third processing to calculate the subsequent output duty D[n+1], based on Equation (2) when it is determined that the discrete three-phase current I[n] exceeds the target current value Itgt; and
in Equation (2), Vin represents the DC voltage that is input to the inverter, and Vbemf represents a counter-electromotive voltage of the motor
$$Equation ( 2 )$$
$$D [ n + 1 ] = ( {I}_{tgt} / I [ n ] ) \times D [ n ] - [ ( {V}_{bemf} / {V}_{in} ) \times \{ 1 - ( {I}_{tgt} / I [ n ] ) \} ] . \qquad ( 2 )$$

5. The motor control device according to claim 2, wherein
the controller is configured or programmed to calculate the subsequent output duty D[n+1], based on Equation (3), as the duty calculation processing; and
D′[n] in Equation (3) is expressed in Equation (4)
$$Equation ( 3 )$$
$$D [ n + 1 ] = min ( D [ n ] , {D}^{′} [ n ] ) \qquad ( 3 )$$
$$Equation ( 4 )$$
$${D}^{′} [ n ] = ( {I}_{tgt} / I [ n ] ) \times D [ n ] . \qquad ( 4 )$$

6. The motor control device according to claim 2, wherein
the controller is configured or programmed to calculate the subsequent output duty D[n+1], based on Equation (3), as the duty calculation processing;
D′[n] in Equation (3) is expressed in Equation (5); and
in Equation (5), Vin represents the DC voltage that is input to the inverter, and Vbemf represents a counter-electromotive voltage of the motor
$$Equation ( 3 )$$
$$D [ n + 1 ] = min ( D [ n ] , {D}^{′} [ n ] ) \qquad ( 3 )$$
$$Equation ( 5 )$$
$$\text{?} [ n ] = ( {I}_{tgt} / I [ n ] ) \times D [ n ] - [ ( {V}_{bemf} / {V}_{in} ) \times \{ 1 - ( {I}_{tgt} / I [ n ] ) \} ] \qquad ( 5 )$$
$$\text{?} \text{indicates text missing or illegible when filed}$$

7. The motor control device according to claim 1, wherein the target current value Itgt is a target value of a consumed current of the inverter.

8. The motor control device according to claim 7, wherein
the controller is configured or programmed to execute, as the duty calculation processing:
first processing to determine whether the discrete three-phase current I[n] exceeds the target current value Itgt; and
fourth processing to calculate the subsequent output duty D[n+1], based on Equation (6) when it is determined that the discrete three-phase current I[n] exceeds the target current value Itgt
$$Equation ( 6 )$$
$$D [ n + 1 ] = {I}_{tgt} / I [ n ] . \qquad ( 6 )$$

9. The motor control device according to claim 7, wherein
the controller is configured or programmed to calculate the subsequent output duty D[n+1], based on Equation (7), as the duty calculation processing
$$Equation ( 7 )$$
$$D [ n + 1 ] = min ( D [ n ] , {I}_{tgt} / I [ n ] ) . \qquad ( 7 )$$

10. A motor assembly comprising:
a motor; and
the motor control device according to claim 1, the motor control device being configured or programmed to control the motor by feedback control.
